(19) United States
(12) Patent Application Publication
(10) Pub. No.: US 2017/0261178 A1
(43) Pub. Date: Sep. 14, 2017

(54) COATING COMPOSITION FOR FORMING LIGHT SCATTERING LAYER, OPTICAL MEMBER, LIGHT COVER, AND LIGHT FIXTURE

(71) Applicant: PANASONIC INTELLECTUAL PROPERTY MANAGEMENT CO., LTD., Osaka (JP)

(72) Inventors: Hiroki SHIGENO, Osaka (JP); Shuhei UCHIYAMA, Osaka (JP)

(73) Assignee: PANASONIC INTELLECTUAL PROPERTY MANAGEMENT CO., LTD., Osaka (JP)

(21) Appl. No.: 15/452,050

(22) Filed: Mar. 7, 2017

(30) Foreign Application Priority Data
Mar. 8, 2016 (JP) 2016-044247

(51) Int. Cl. F21V 3/04

(52) U.S. Cl. CPC F21V 3/0481; F21Y 2115/10

(57) ABSTRACT

A coating composition for forming a light scattering layer includes a light transmitting resin containing an acrylic resin, and resin particles containing a fluororesin having a refractive index of 1.40 or less. The resin particles are contained in the amount of 100 to 400 parts by mass per 100 parts by mass of the light transmitting resin on a solids basis.

### BACKGROUND OF THE INVENTION

Technical Field

The disclosure relates to a coating composition for forming a light scattering layer, an optical member, a light cover, and a light fixture. More particularly, the disclosure relates to a coating composition for forming a light scattering layer having high light transmitting and scattering properties, and an optical member, a light cover, and a light fixture using the coating composition.

Background Art

Light fixtures are typically provided with light covers for covering light sources. Light covers generally include optical members having light transmitting and scattering properties. A light cover having light transmitting and scattering properties can scatter light emitted from a light source over an entire light transmitting surface of the light cover. Accordingly, the amount of transmitted light per area on the entire light transmitting surface can be equalized, so as to prevent unevenness of brightness on the light transmitting surface. The uniformity of the amount of transmitted light per area can enhance the quality of appearance of the light fixture while concealing a direct image of the light source.

Typically, optical members having light transmitting and scattering properties are manufactured by molding resin sheets containing white pigments. Examples of white pigments used include silicon oxide, barium sulfate, calcium carbonate, titanium oxide, mica, magnesium oxide, talc, aluminum hydroxide, and aluminum oxide. An increase of content of white pigments can provide the optical members with high light scattering performance. These pigments, which have the light scattering properties, may decrease the light transmittance as the content of the pigments increases. The optical members having higher light scattering properties may lead to lower light transmittance. Furthermore, inorganic particles used as the white pigments may degrade surfaces of the optical members to result in surface chalking.

JP 2012-208424 discloses a light scattering coating composition containing an acrylic resin, a fluororesin, and light scattering particles and used for a light scattering member. The coating composition disclosed in JP 2012-208424 contains the fluororesin in the amount of 0.3 to 20 parts by mass per 100 parts by mass of the acrylic resin, and contains the light scattering particles in the amount of 0.3 to 20 parts by mass per 100 parts by mass of the acrylic resin.

Light emitting diode (LED) light fixtures, which are in increasing demand in response to the acceleration of energy savings, are required to use optical members having much higher light transmittance in order to efficiently supply light with lower power consumption. Further, since LED light sources have strong directivity, optical members are required to have high light scattering performance and screen the LED light sources so as not to be recognized as point light sources.

### SUMMARY OF THE INVENTION

An object of this disclosure is to provide a coating composition for forming a light scattering layer having high light transmitting and scattering properties, and an optical member, a light cover, and a light fixture using the coating composition.

In order to solve the above-described problems, a coating composition for forming a light scattering layer according to a first aspect of the present invention includes: a light transmitting resin containing an acrylic resin; and resin particles containing a fluororesin having a refractive index of 1.40 or less. The resin particles are contained in an amount of 100 to 400 parts by mass per 100 parts by mass of the light transmitting resin on a solids basis.

An optical member according to a second aspect of the present invention includes: a light transmitting resin substrate; and a light scattering layer including a light transmitting resin containing an acrylic resin, and resin particles containing a fluororesin having a refractive index of 1.40 or less, the light scattering layer being provided on one surface of the light transmitting resin substrate. The resin particles are contained in the light scattering layer in an amount of 100 to 400 parts by mass per 100 parts by mass of the light transmitting resin on a solids basis.

A light cover according to a third aspect of the present invention includes the optical member according to the second aspect.

A light fixture according to a fourth aspect of the present invention includes the light cover according to the third aspect and a light source.

According to the embodiment of the present invention, a coating composition for forming a light scattering layer having high light transmitting and scattering properties, and an optical member, a light cover, and a light fixture using the coating composition can be provided.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is a cross-sectional view showing an example of an optical member according to the present embodiment.

FIG. 2 is a schematic view illustrating the behavior of light on surfaces of resin particles in the present embodiment.

FIG. 3 is a schematic view illustrating the behavior of light on a surface of a light scattering layer in the present embodiment.

FIG. 4 is a cross-sectional view showing an example of a light cover and a light fixture according to the present embodiment.

### DETAILED DESCRIPTION

A coating composition for forming a light scattering layer, and an optical member, a light cover, and a light fixture using the coating composition according to the present embodiment will be described below with reference to the drawings.

### [Coating Composition for Forming Light Scattering Layer]

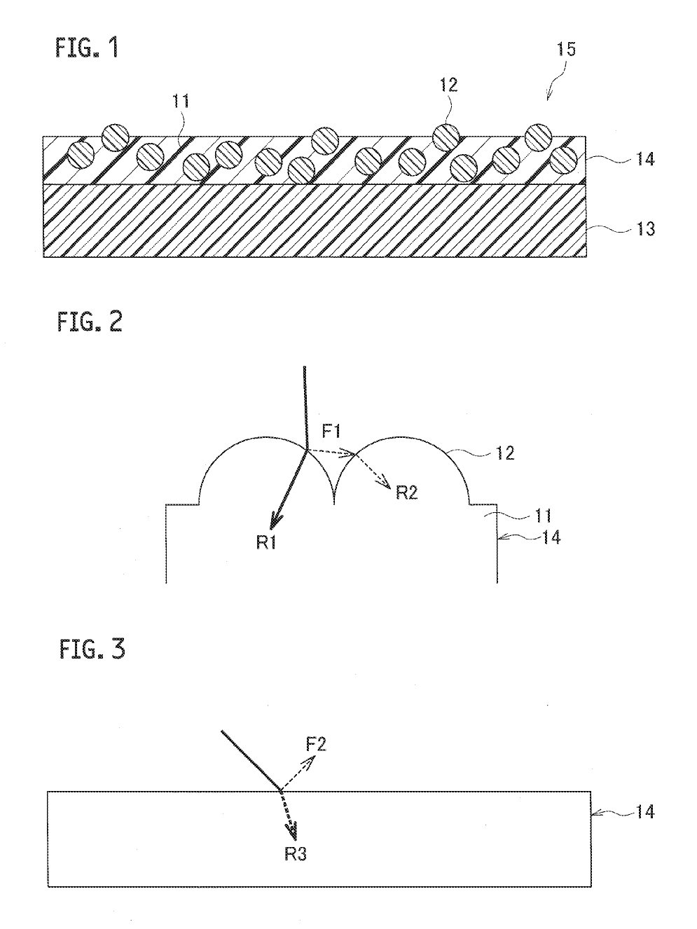

A coating composition for forming a light scattering layer according to the present embodiment includes a light transmitting resin 11 containing an acrylic resin, and resin particles 12 containing a fluororesin having a refractive index of 1.40 or less. The resin particles 12 is contained in the amount of 100 to 400 parts by mass per 100 parts by mass of the light transmitting resin 11 on a solids basis. When the coating composition is applied to, for example, a light transmitting resin substrate 13 as described below, an optical member 15 including a light scattering layer 14 is obtained, as shown in FIG. 1.

The coating composition includes the light transmitting resin 11 containing the acrylic resin and the resin particles 12. The content of the resin particles 12 is in the range of 100 to 400 parts by mass per 100 parts by mass of the light transmitting resin 11 on a solids basis. The resin particles 12 with the content of 100 parts by mass or greater can improve the light scattering properties due to a refractive index difference between the light transmitting resin 11 and the resin particles 12, so as to obtain the coating composition having high light scattering performance. In addition, the resin particles 12 with the content of 100 parts by mass or greater are suitably exposed on a surface of a coating film composing the light scattering layer 14 when the coating composition is applied to the light transmitting resin substrate 13. The exposure of the resin particles 12 provides spherical lens-like convex portions as shown in FIG. 2. Refracted light R1 from an air layer directly enters the light scattering layer 14 via the convex portion, and light F1 reflected by Fresnel reflection at the boundary between the air layer and the light scattering layer 14 also enters the adjacent convex portion as refracted light R2, so as to increase the effectiveness of light introduction. The enhancement of the light introduction increases the light transmittance. Further, the resin particles 12 with the content of 400 parts by mass or less can favorably be dispersed in the light transmitting resin 11, so as to obtain the coating composition having high light transmittance. Namely, the resin particles 12 present in the amount as described above can provide the coating composition ensuring the light transmitting and scattering properties simultaneously.

The light transmitting resin 11 may be any resin that contains an acrylic resin and has light transmitting properties, and preferably has total luminous transmittance of 90% or greater. The total luminous transmittance may be measured with a haze meter (NDH 2000, available from NIPPON DENSHOKU INDUSTRIES CO., LTD.) in accordance with Japanese Industrial Standards JIS K7361-1 (Plastics-Determination of the total luminous transmittance of transparent materials—Part 1: Single beam instrument).

The acrylic resin is obtained by polymerization of monomers containing at least one of acrylate and methacrylate. The acrylate may be at least one kind selected from the group consisting of methyl acrylate, ethyl acrylate, butyl acrylate, 2-ethyl hexyl acrylate, isobornyl acrylate, glycidyl acrylate, benzil acrylate, stearyl acrylate, lauryl acrylate, and 2-hydroxy-3-phenoxypropyl acrylate. The methacrylate may be at least one kind selected from the group consisting of methyl methacrylate, ethyl methacrylate, butyl methacrylate, 2-ethyl hexyl methacrylate, isobornyl methacrylate, glycidyl methacrylate, benzil methacrylate, stearyl methacrylate, lauryl methacrylate, and 2-hydroxy-3-phenoxypropyl methacrylate.

Alternatively, the acrylic resin may be a copolymer of a monomer containing at least one of acrylate and methacrylate and a monomer having a carbon-carbon double bond. The monomer having a carbon-carbon double bond may be at least one kind selected from the group consisting of a styrene-based monomer, an olefin-based monomer, and a vinyl-based monomer. An example of the styrene-based monomer may be styrene. An example of the olefin-based monomer may be ethylene or propylene. An example of the vinyl-based monomer may be vinyl chloride or vinylidene chloride. These monomers may be used singly or in combination.

The resin particles 12 may be any material that contains a fluororesin having a refractive index of 1.40 or less. The resin particles 12 with the refractive index of 1.40 or less decreases the refractive index difference between the air layer on the light source side and the light scattering layer 14 when the coating composition is applied to the light transmitting resin substrate 13. As a result, as shown in FIG. 3, the amount of light F2 reflected by Fresnel reflection from the surface of the light scattering layer 14 decreases, while the amount of refracted light R3 increases, so as to increase the effectiveness of light introduction from the light source, and accordingly, increase the light transmittance. The refractive index of the resin particles 12 is preferably 1.32 or greater and 1.38 or less. The resin particles 12 with the refractive index in this range can provide the coating composition having higher light transmittance. As used herein, the term “refractive index” refers to a value at the NaD line (589 nm) measured with an Abbe refractometer.

The fluororesin is obtained by polymerization of monomers containing at least a fluorine. The monomer containing a fluorine may be at least one kind selected from the group consisting of tetrafluoroethylene, chlorotrifluoroethylene, vinylidene fluoride, vinyl fluoride, fluorovinyl ether, and hexafluoropropylene.

Alternatively, the fluororesin may be a copolymer of a monomer containing a fluorine and a monomer having a carbon-carbon double bond. The monomer having a carbon-carbon double bond may be at least one kind selected from the group consisting of a styrene-based monomer, an olefin-based monomer, a vinyl-based monomer, and an acrylic monomer. An example of the styrene-based monomer may be styrene. An example of the olefin-based monomer may be ethylene or propylene. An example of the vinyl-based monomer may be vinyl chloride or vinylidene chloride. An example of the acrylic monomer may be acrylate or methacrylate. These monomers may be used singly or in combination.

An example of the fluororesin may be at least one kind selected from the group consisting of a polytetrafluoroethylene (PTFE) resin, a polychlorotrifluoroethylene (PCTFE) resin, a polyvinylidene fluoride (PVDF) resin, a polyvinyl fluoride (PVF) resin, a tetrafluoroethylene-perfluoroalkyl vinyl ether (PFA) copolymer, a tetrafluoroethylene-hexafluoropropylene (FEP) copolymer, an ethylene-tetrafluoroethylene (ETFE) copolymer, and an ethylene-chlorotrifluoroethylene (ECTFE) copolymer. The fluororesin is preferably a polytetrafluoroethylene (PTFE) resin. The polytetrafluoroethylene (PTFE) resin, which has a low refractive index, can minimize the Fresnel reflection on the surface of the light scattering layer 14, so as to provide the coating composition having higher light transmittance. The polytetrafluoroethylene (PTFE) resin may be polytetrafluoroethylene which is a homopolymer of tetrafluoroethylene monomers. The polytetrafluoroethylene resin may be copolymerized with a tetrafluoroethylene monomer containing a monomer other than tetrafluoroethylene in the amount of at most about 30 mol %. The polytetrafluoroethylene (PTFE) resin may be either an unmodified polytetrafluoroethylene resin or a modified polytetrafluoroethylene resin.

An average particle size (D50) of the resin particles 12 is preferably, but not necessarily, 1 μm or greater and 20 μm or less. When the average particle size of the resin particles 12 is 1 μm or greater, light easily collides with the resin particles 12, so as to enhance the light scattering performance. The resin particles 12 with the average particle size of 1 μm or greater can provide a sufficient amount of convex portions on the surface of the light scattering layer 14. The sufficient amount of convex portions contributes to the enhancement of the light introduction to the light scattering layer 14, so as to increase the light transmittance of the optical member 15. In addition, the resin particles 12 with the average particle size of 20 μm or less can favorably be dispersed in the light scattering layer 14, so as to improve the light transmittance of the optical member 15. The average particle size of the resin particles 12 is more preferably 10 μm or less, particularly preferably less than 3 μm. The resin particles 12 having such an average particle size can further increase the light transmittance of the optical member 15. The average particle size (D50) of the resin particles 12 may be measured by a laser diffraction/scattering method with a laser diffraction particle size analyzer.

The coating composition may contain a dispersant for finely dispersing the resin particles 12 in the light transmitting resin 11. The dispersant may be any kind and contained in any amount that can disperse the resin particles 12 in the light transmitting resin 11 appropriately.

The coating composition may further contain a solvent for finely dispersing the resin particles 12 in the light transmitting resin 11. The solvent may be any kind that can disperse the resin particles 12 in the light transmitting resin 11 appropriately. An example of the solvent may be at least one kind selected from the group consisting of: an aromatic solvent such as toluene and xylene; a ketone solvent such as methyl ethyl ketone and cyclohexanone; and an ester solvent such as ester acetate.

The coating composition may optionally contain commonly-used additives depending on the purposes. Examples of additives include a UV absorber, a light stabilizer, a defoaming agent, and a leveling agent. The UV absorber may be at least one kind selected from the group consisting of a benzotriazole UV absorber, a triazine UV absorber, and a salicylic acid derivative UV absorber. The light stabilizer may be a hindered amine stabilizer, and the defoaming agent may be selected from various types of surfactants.

As described above, the coating composition for forming a light scattering layer includes the light transmitting resin 11 containing the acrylic resin, and the resin particles 12 containing the fluororesin with the refractive index of 1.40 or less. The resin particles 12 is contained in the amount of 100 to 400 parts by mass per 100 parts by mass of the light transmitting resin 11 on a solids basis. Accordingly, a light scattering layer can be obtained that exhibits high light transmitting and scattering properties when the coating composition is applied to the light transmitting resin substrate 13.

### [Optical Member]

The optical member 15 according to the present embodiment includes the light transmitting resin substrate 13; and the light scattering layer 14 including the light transmitting resin 11 containing the acrylic resin, and the resin particles 12 containing the fluororesin having the refractive index of 1.40 or less, the light scattering layer 14 is provided on one surface of the light transmitting resin substrate 13. The resin particles 12 is contained in the light scattering layer 14 in an amount of 100 to 400 parts by mass per 100 parts by mass of the light transmitting resin 11 on a solids basis.

The light transmitting resin substrate 13 may include any resin that has light transmitting properties, and preferably has total luminous transmittance of 90% or greater. The total luminous transmittance may be measured with a haze meter in accordance with JIS K7361-1.

The light transmitting resin substrate 13 may include at least one kind selected from the group consisting of an acrylic resin, a polyester resin, a polycarbonate resin, and a styrene resin. The light transmitting resin substrate 13 preferably includes at least one of the acrylic resin and the polycarbonate resin because these resins have higher light transmittance than other resins. The acrylic resin may be the same as that used in the light transmitting resin 11. The polycarbonate resin may be any polymer that has a carbonate bond in a main chain. The polycarbonate resin may be a polymer obtained by a reaction between bisphenol and phosgene or between bisphenol and diphenyl carbonate.

The light transmitting resin substrate 13 may include either a thermoplastic resin or a thermosetting resin. When the light transmitting resin substrate 13 is processed after the optical member 15 according to the present embodiment is obtained, the light transmitting resin substrate 13 is preferably a thermoplastic resin so as to be elongated and molded to conform to a predetermined shape.

The thickness of the light transmitting resin substrate 13 is preferably, but not necessarily, in the range of 0.1 mm to 3 mm. The thickness of the light transmitting resin substrate 13 is more preferably in the range of 1 mm to 2 mm in order to ensure moldability and strength. The light transmitting resin substrate 13 may be obtained by a sheet molding method such as glass casting, continuous casting, and extrusion.

The light scattering layer 14 is preferably provided on one surface of the light transmitting resin substrate 13. As described in detail below, when the optical member 15 is used in a light fixture 100, the light scattering layer 14 may be provided on one surface of the light transmitting resin substrate 13 such that the light scattering layer 14 is located on the light source side.

The light scattering layer 14 includes a light transmitting resin 11, and resin particles 12 containing a fluororesin having a refractive index of 1.40 or less. The light transmitting resin 11 and the resin particles 12 may be the same as those used for the coating composition.

The light scattering layer 14 may be obtained such that the coating composition described above is applied to the light transmitting resin substrate 13. Preferable examples of methods of applying the coating composition include, but are not limited to, spray coating, dip coating, flow coating, spin coating, roll coating, brush coating, and sponge coating. When the coating composition contains an organic solvent, the organic solvent is removed by heating, for example, so as to form the light scattering layer 14 on the surface of the light transmitting resin substrate 13.

The thickness of the light scattering layer 14 is preferably, but not necessarily, 5 μm or greater and 20 μm or less. The light scattering layer 14 with the thickness of 5 μm or greater can exert higher light scattering performance. The light scattering layer 14 with the thickness of 20 μm or less can easily be provided, on the surface thereof, with the convex portions derived from the resin particles 12. The convex portions enhance the introduction of light into the light scattering layer 14, so as to increase the light transmittance of the optical member 15. The thickness of the light scattering layer 14 is more preferably 7 μm or greater and 15 μm or less. The light scattering layer 14 with the thickness in this range can provide the optical member 15 having higher light transmitting and scattering properties. Since the light scattering layer 14 is provided with the convex portions on the surface thereof, the thickness of the light scattering layer 14 is preferably adjusted in view of the average particle size of the resin particles 12.

The optical member 15 according to the present embodiment includes the light transmitting resin substrate 13; and the light scattering layer 14 including the light transmitting resin 11 containing the acrylic resin, and the resin particles 12 containing the fluororesin having the refractive index of 1.40 or less, the light scattering layer 14 is provided on one surface of the light transmitting resin substrate 13. The resin particles 12 is contained in the light scattering layer 14 in the amount of 100 to 400 parts by mass per 100 parts by mass of the light transmitting resin 11 on a solids basis. Accordingly, the optical member 15 having high light transmitting and scattering properties can be obtained.

### [Light Cover]

A light cover 40 according to the present embodiment is described below. The light cover 40 according to the present embodiment uses the optical member 15. Namely, the light cover 40 according to the present embodiment includes the optical member 15.

The light cover 40 preferably, but not necessarily, has a shape suitably covering a lamp as a light source 30. The light cover 40 may be attached while covering a radiation part of the lamp either entirely or partially. The light cover 40 may have a plate shape or, alternatively, may be molded by extrusion into a shape suitable for the covering of the lamp.

The light cover 40 may be applicable to various types of light fixtures. Examples of light fixtures to which the light cover 40 is attached include a ceiling light, a pendant light, a kitchen light, a bathroom light, a chandelier, a stand light, a bracket light, and a paper lantern. Other examples include a garage light, a light under an eaves, a gate post light, a porch light, a garden light, an entrance light, a footlight, a stair light, an exit sign, a security light, a downlight, a base light, illuminations, and a sign light. The light cover 40 may also be applicable to lamps used for vehicles such as an automobile and a motorcycle. As described below, the light cover 40 is particularly favorably applicable to a ceiling light having a structure in which the light cover 40 is held by a fixture body 20.

As described above, the light cover 40 according to the present embodiment includes the optical member 15, so as to provide the light cover 40 with high light transmitting and scattering properties.

### [Light Fixture]

A light fixture 100 according to the present embodiment is described below. The light fixture 100 according to the present embodiment includes the light cover 40 and the light source 30. The light fixture 100 may also include the fixture body 20 having an opening 21, the light source 30 provided in the fixture body 20, and the light cover 40 for covering the opening 21.

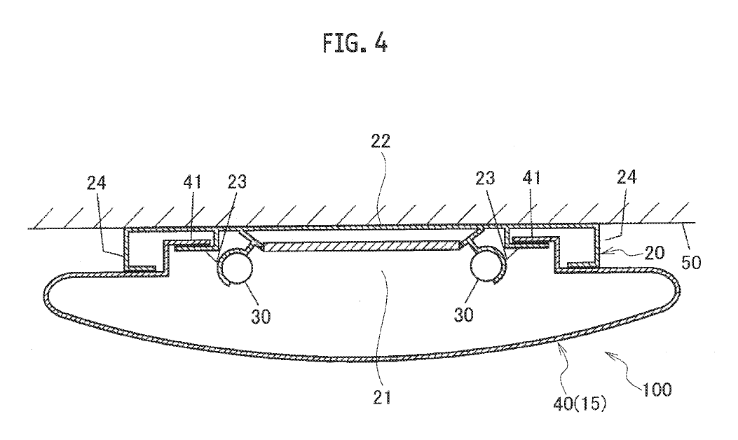

FIG. 4 illustrates an example of the light fixture 100. The light fixture 100 is a circular ceiling light. Although FIG. 4 illustrates the circular ceiling light, the light fixture 100 may be a polygonal ceiling light.

The fixture body 20 includes a base 22, an engaged portion 23, and a support portion 24, for example. The base 22 may be mounted on a mount surface on a ceiling 50, for example, depending on the purposes. The engaged portion 23 is engaged with an engaging portion 41 of the light cover 40. The engaged portion 23 projects outward on the fixture body 20, as shown in FIG. 4. The support portion 24 externally supports the light cover 40 so as to prevent the light cover 40 from being shifted or unsteadily attached. The support portion 24 projects downward on the outside of the engaged portion 23 on the fixture body 20. The engaged portion 23 and the support portion 24 may be provided along the circumference of or in part of the fixture body 20. The fixture body 20 may be mounted on the ceiling 50 as illustrated in FIG. 4, or may be used for any application, such as a paper lantern, depending on the purposes.

The fixture body 20 may include the opening 21. The opening 21 may have any shape and size that can be covered with the light cover 40. As illustrated in FIG. 4, the opening 21 may be located on the opposite side of the mount surface of the base 22, and may be surrounded by the support portion 24.

The light source 30 may be provided in the fixture body 20. The light source 30 may be provided on the inside of the opening 21 of the fixture body 20. The light source 30 may be any light source such as a point light source, a linear light source, and a surface light source. Examples of the light source 30 include, but are not limited to, a light emitting diode (LED), a fluorescent light, an incandescent light, and a high-intensity discharge (HID) lamp. The light fixture 100 according to the present embodiment has high light transmitting and scattering properties and is therefore suitably used with an LED light source so as to contribute to energy savings. The light source 30 may include a single light source or a plurality of light sources.

The engaging portion 41 may be provided at the upper portion of the light cover 40 so as to be hung on the fixture body 20. FIG. 4 illustrates the engaging portion 41 projecting to the inner side of the fixture body 20. The engaging portion 41 may be provided along the circumference of or in part of the light cover 40.

The light cover 40 can cover the opening 21. For example, as illustrated in FIG. 4, the light cover 40 having a substantial C-shape in cross section may be attached to the fixture body 20 from the lower side so as to cover the light source 30. The light scattering layer 14 is preferably located closer to the light source 30 than the light transmitting resin substrate 13. Accordingly, the light fixture 100 having high light transmittance can be obtained due to the convex portions provided on the surface of the light scattering layer 14.

As described above, the light fixture 100 according to the present embodiment includes the light cover 40 and the light source 30. Thus, the light fixture 100 having high light transmitting and scattering properties can be provided even when a light source having strong directivity, such as an LED light source, is used.

### EXAMPLES

The present embodiment is described in more detail below with reference to Examples and Comparative Examples, but not limited to these examples.

### Example 1

First, resin particles were added in the amount of 100 parts by mass per 100 parts by mass of a light transmitting resin on a solids basis. As the light transmitting resin, ACRYDIC (registered trademark) WAL-578 (available from DIC Corporation) was used. A refractive index of ACRYDIC (registered trademark) WAL-578 is 1.49. As the resin particles, KTL-1N (available from KITAMURA LIMITED) was used. KTL-1N is a polytetrafluoroethylene resin. A refractive index and an average particle size of KTL-1N are 1.35 and 2 m, respectively.

In order to disperse the resin particles, a dispersant DISPERBYK (registered trademark) 142 (available from BYK Chemie) was added in the amount of 50 parts by mass per 100 parts by mass of the resin particles. The mixture was diluted with propylene glycol monomethyl ether acetate so that the entire solids content resulted in 20 mass %. The diluted solution was ultrasonically stirred until the solids were evenly dispersed, so as to obtain a coating material.

The coating material was sprayed on an acrylic plate of 256 mm square and 1.5 mm thick, and the solvent was dried at 80° C. for 10 minutes, so as to obtain an optical member in which a light scattering layer was formed on the surface of a light transmitting resin substrate. The acrylic plate used was ACRYLITE (registered trademark) L001 (available from MITSUBISHI RAYON CO., LTD.). A haze and total luminous transmittance of the acrylic plate was 0.2% and 92.5%, respectively.

The film thickness of the light scattering layer was determined as appropriate such that the optical member could exhibit sufficient light scattering performance. In particular, several optical members having light scattering layers with different thicknesses were prepared, and an optical member having a thickness by which a scattering coefficient resulted in approximately 60% was selected, so as to be used as Example. The method of measuring the scattering coefficient is described below.

The optical member thus obtained was used for a light cover and attached to an LED base light XL553PFV LE9 (available from Panasonic Corporation) such that the light scattering layer was located on the light source side, so as to obtain a light fixture of this example.

### Example 2

A light fixture of this example was obtained by the same process as in Example 1 except that the resin particles were added in the amount of 150 parts by mass per 100 parts by mass of the light transmitting resin on a solids basis.

### Example 3

A light fixture of this example was obtained by the same process as in Example 1 except that the resin particles were added in the amount of 233 parts by mass per 100 parts by mass of the light transmitting resin on a solids basis.

### Example 4

A light fixture of this example was obtained by the same process as in Example 1 except that the resin particles were added in the amount of 400 parts by mass per 100 parts by mass of the light transmitting resin on a solids basis.

### Comparative Example 1

A light fixture of this example was obtained by the same process as in Example 1 except that the resin particles were added in the amount of 67 parts by mass per 100 parts by mass of the light transmitting resin on a solids basis.

### Comparative Example 2

A light fixture of this example was obtained by the same process as in Example 1 except that the resin particles were added in the amount of 567 parts by mass per 100 parts by mass of the light transmitting resin on a solids basis.

### Comparative Example 3

A light fixture of this example was obtained by the same process as in Example 1 except that Tospearl (registered trademark) 120 (available from Momentive Performance Materials Inc.) was used as the resin particles instead of KTL-1N used in Example 1. Tospearl (registered trademark) 120 is a silicone resin, and a refractive index is 1.43 and an average particle size is 2 μm.

### Comparative Example 4

A light fixture of this example was obtained by the same process as in Example 1 except that EPOSTAR (registered trademark) S12 (available from NIPPON SHOKUBAI CO., LTD.) was used as the resin particles instead of KTL-1N used in Example 1. EPOSTAR (registered trademark) S12 is a melamine-formaldehyde condensate, and a refractive index is 1.60 and an average particle size is 2 μm.

TABLE 1

| | Light Scattering Layer | | | Evaluation | | | |
|---|---|---|---|---|---|---|---|
| | | Resin | | Emission | | Light | |
| | Thick- | Particles | | Efficiency | | Uniformity | |
| | ness | Refractive | Parts | | Re- | | Re- |
| | (μm) | Index | by Mass | % | sult | % | sult |
| Example 1 | 35 | 1.35 | 100 | 100.0 | Good | 83.1 | Good |
| Example 2 | 24 | 1.35 | 150 | 101.5 | Good | 80.0 | Good |
| Example 3 | 16 | 1.35 | 233 | 101.4 | Good | 75.2 | Good |
| Example 4 | 12 | 1.35 | 400 | 100.7 | Good | 80.0 | Good |
| Comparative | 40 | 1.35 | 67 | 99.1 | Bad | 80.8 | Good |
| Example 1 | | | | | | | |
| Comparative | 13 | 1.35 | 567 | 99.0 | Bad | 82.3 | Good |
| Example 2 | | | | | | | |
| Comparative | 15 | 1.43 | 100 | 102.0 | Good | 12.1 | Bad |
| Example 3 | | | | | | | |
| Comparative | 16 | 1.60 | 100 | 98.6 | Bad | 77.0 | Good |
| Example 4 | | | | | | | |

### [Evaluation]

The light fixtures obtained in Examples 1 to 4 and Comparative Examples 1 to 4 were evaluated in terms of the following items. Table 1 summarizes the specifications and evaluation results of the respective examples.

### [Emission Efficiency]

The total luminous flux of the light fixture obtained in the respective examples was measured, and a ratio of the total luminous flux of each example to the total luminous flux of Example 1 (set to 100) was calculated. The total luminous flux was measured with a 165 cm diameter integrating sphere by a measurement system (available from Labsphere Inc.). The evaluation criteria are as follows:

100% or greater: Good

Less than 100%: Bad

### [Light Uniformity]

Because the LED base light XL553PFV LE9 was not appropriate to evaluate the light uniformity since the distance between the light sources was small, two LEDs three centimeters distant from each other were covered with the light cover obtained in each example, so as to evaluate the light uniformity. The LEDs used were NSSW157D (available from Nichia Corporation). The light cover was placed at a position three centimeters distant from the LEDs such that the light scattering layer was located on the LED side. A 2D color analyzer CA-2000 (available from KONICA MINOLTA, INC.) was placed at a position about 30 centimeters distant from the light cover. Then, maximum and minimum values of luminance on the segment between the two LEDs were measured. The light uniformity was calculated according to [(minimum luminance)/(maximum luminance)]×100. The evaluation criteria are as follows:

70% or greater: Good

Less than 70%: Bad

### [Scattering Coefficient]

The scattering coefficient was calculated according to the following equation.

Scattering coefficient (%)=[{(luminance at 20°)+(luminance at 70°)}/(luminance at 5°)]/2×100

The values of luminance (cd/m²) were measured such that the optical member of each example was placed in a rotation axis with the light scattering layer located on the light source side, and the angle of the rotation axis was changed to 5°, 20°, and 70°. The light source used was LA-50UE (available from HAYASHI WATCH-WORKS CO., LTD.). A luminance meter used was BM-7 (available from TOPCON TECHNOHOUSE CORPORATION). The light source was adjusted by a spot adjuster. The distance between the spot adjuster and the rotation axis was set to 620 mm, and the distance between the rotation axis and the luminance meter was set to 340 mm.

In Examples 1 to 4, the content of the resin particles is 100 to 400 parts by mass per 100 parts by mass of the light transmitting resin on a solids basis. Examples 1 to 4 use the fluororesin with the refractive index of 1.40 or less as the resin particles. The optical members of Examples 1 to 4 satisfied the predetermined evaluation criteria for the emission efficiency and the light uniformity. The optical members of Examples 1 to 4 were thus recognized as exhibiting both high light transmitting and scattering properties.

The optical member of Comparative Example 1 includes the resin particles in the amount of 67 parts by mass per 100 parts by mass of the light transmitting resin. Comparative Example 1 could not sufficiently ensure the effectiveness of light scattering, or not satisfy the predetermined evaluation criterion for the emission efficiency because the thickness was increased in order to satisfy the evaluation criterion for the light uniformity. The optical member of Comparative Example 1 thus could not ensure the light transmitting and scattering properties simultaneously.

The optical member of Comparative Example 2 includes the resin particles in the amount of 567 parts by mass per 100 parts by mass of the light transmitting resin. Comparative Example 2 satisfied the evaluation criterion for the light uniformity, but could not satisfy the evaluation criterion for the emission efficiency, since the resin particles were aggregated. The optical member of Comparative Example 2 thus could not ensure the light transmitting and scattering properties simultaneously.

The optical member of Comparative Example 3 includes the silicone resin with the refractive index of 1.43 as the resin particles. Comparative Example 3 could not satisfy the evaluation criterion for the light uniformity, which may be because the difference between the refractive index (1.49) of the acrylic resin used as the light transmitting resin and the refractive index (1.43) of the silicone resin used as the resin particles was not sufficient, thereby leading to a decrease in light scattering performance. Although not shown in Table, the optical member of Comparative Example 3 could hardly increase the light uniformity even when the thickness of the light scattering layer was increased. The optical member of Comparative Example 3 thus could not ensure the light transmitting and scattering properties simultaneously.

The optical member of Comparative Example 4 includes the melamine-formaldehyde condensate with the refractive index of 1.60 as the resin particles. Comparative Example 4 could not satisfy the evaluation criterion for the emission efficiency, which may be because the difference of the refractive indexes between the air layer on the light source side and the light scattering layer increased due to the excessively-large refractive index of the resin particles, thereby increasing the Fresnel reflection to result in a decrease in light transmittance. The optical member of Comparative Example 4 thus could not ensure the light transmitting and scattering properties simultaneously.

While the foregoing has described what is considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

The entire content of Japanese Patent Application No. 2016-044247 (filed on Mar. 8, 2016) is incorporated herein by reference.

1. A coating composition for forming a light scattering layer, comprising:
a light transmitting resin containing an acrylic resin; and
resin particles containing a fluororesin having a refractive index of 1.40 or less, the resin particles being contained in an amount of 100 to 400 parts by mass per 100 parts by mass of the light transmitting resin on a solids basis.

2. The coating composition for forming a light scattering layer according to claim 1, wherein the fluororesin is a polytetrafluoroethylene resin.

3. An optical member comprising:
a light transmitting resin substrate; and
a light scattering layer including a light transmitting resin containing an acrylic resin, and resin particles containing a fluororesin having a refractive index of 1.40 or less, the light scattering layer being provided on one surface of the light transmitting resin substrate,
the resin particles being contained in the light scattering layer in an amount of 100 to 400 parts by mass per 100 parts by mass of the light transmitting resin on a solids basis.

4. The optical member according to claim 3, wherein the fluororesin is a polytetrafluoroethylene resin.

5. A light cover comprising the optical member according to claim 3.

6. A light fixture comprising:
the light cover according to claim 5; and
a light source.

7. The light fixture according to claim 6, wherein the light scattering layer is located closer to the light source than the light transmitting resin substrate.
